(19) United States
(12) Patent Application Publication
(10) Pub. No.: US 2026/0305528 A1
(43) Pub. Date: Oct. 8, 2026

(54) MOWER DECK WITH TORQUE MONITORING

(71) Applicant: THE TORO COMPANY, Bloomington, MN (US)

(72) Inventors: Brian R. Hendrickson, Minneapolis, MN (US); Nathan A. Reiman, Bloomington, MN (US); Nathaniel L. Smith, Eagan, MN (US); Matthew J. Decker, Lakeville, MN (US); Samuel B. Dando, Minnetonka, MN (US); Tony L. Ferguson, Chanhassen, MN (US)

(21) Appl. No.: 19/481,716

(22) PCT Filed: Apr. 22, 2024
(86) PCT No.: PCT/US2024/025631

§ 371 Date: Nov. 5, 2025

Related U.S. Application Data
(60) Provisional application No. 63/467,075, filed on May 17, 2023.

(51) Int. Cl. A01D 34/00; A01D 34/66; A01D 34/78; A01D 69/02; A01D 101/00

(52) U.S. Cl. CPC A01D 34/008; A01D 34/66; A01D 34/78; A01D 69/02; A01D 2101/00

(57) ABSTRACT

A grounds maintenance machine comprises a frame, drive members connected to the frame, and a propulsion system providing power to the drive members. A cutting deck is connected to the frame and comprises a deck motor to rotate a cutting blade. A controller is operatively coupled to the propulsion system and the cutting deck. The controller is configured to determine a rotational speed of the cutting blade, a current provided to the deck motor, and a voltage provided to the deck motor. The controller is configured to estimate a torque of the cutting blade based on the rotational speed, the current, the voltage, and a torque profile of the deck motor. The controller is configured to adjust, based on the estimated torque of the cutting blade, one or both of a speed limit of the propulsion system and a blade speed of the cutting blade.

The present application claims priority to and/or the benefit of U.S. Provisional Patent Application No. 63/467,075, filed May 17, 2023, which is incorporated herein by reference in its entirety.

The present disclosure relates to grounds maintenance machines such as ride-on, stand-on, walk-behind or tow-behind lawn mowers and, more particularly, to such machines incorporating electric motors.

### SUMMARY

Embodiments of the present disclosure relate to motor and speed control of grounds maintenance machines that include electric motors. In particular, embodiments of the present disclosure are directed to estimation of a torque of one or more working implements of a grounds maintenance machine and adjustment of a rotational speed of the one or more working implements and/or a speed of the grounds maintenance machine based on the determined torque. The techniques of the present disclosure allow torque to be estimated above a knee point of electric motors, to use power more efficiently, and to maintain cut quality while performing work.

In one aspect, the present disclosure relates to a grounds maintenance machine comprising a frame having a front end and a rear end, one or more drive members connected to the frame and adapted to propel the machine over a ground surface, and a propulsion system configured to provide power to each of the one or more drive members. A cutting deck is connected to the frame and comprises a cutting blade and a deck motor operatively coupled to the cutting blade to rotate the cutting blade. A controller comprises one or more processors operatively coupled to the propulsion system and the deck motor. The controller is configured to determine a blade speed of the cutting blade, determine a motor current provided to the deck motor, determine a motor voltage provided to the deck motor, and estimate a torque of the cutting blade based on the blade speed, the motor current, the motor voltage, and a torque profile of the deck motor. The controller is configured to adjust, based on the estimated torque of the cutting blade, one or both of a speed limit of the propulsion system and the blade speed of the cutting blade.

In another aspect, the present disclosure relates to a grounds maintenance machine comprising a frame having a front end and a rear end, one or more drive members connected to the frame and adapted to propel the machine over a ground surface, and a propulsion system configured to provide power to each of the one or more drive members. A cutting deck is connected to the frame and comprises a cutting blade, a blade spindle operatively coupled to the cutting blade, and a deck motor operatively coupled to the blade spindle to rotate the cutting blade. A controller comprises one or more processors operatively coupled to the propulsion system and the cutting deck. The controller is configured to determine a rotational speed of the cutting blade, determine a current provided to the deck motor, determine a voltage provided to the deck motor, and estimate a torque of the cutting blade based on the rotational speed, the current, the voltage, and a torque profile of the deck motor. The controller is configured to set the rotational speed of the cutting blade to a minimum speed in response to the estimated torque being less than a lower torque threshold, set the rotational speed of the cutting blade to a maximum speed in response to the estimated torque being greater than an upper torque threshold, and adjust the speed of the cutting blade to a blade speed related to the estimated torque in response to the estimated torque being greater than the lower torque threshold and less than the upper torque threshold.

In a further aspect, the present disclosure relates to a grounds maintenance machine comprising a frame having a front end and a rear end, one or more drive members connected to the frame and adapted to propel the machine over a ground surface, and a propulsion system configured to provide power to each of the one or more drive members. A cutting deck is connected to the frame and comprises a cutting blade, a blade spindle operatively coupled to the cutting blade, and a deck motor operatively coupled to the blade spindle to rotate the cutting blade. A controller comprises one or more processors operatively coupled to the propulsion system and the cutting deck. The controller is configured to determine a blade speed of the cutting blade, determine a motor current provided to the deck motor, determine a motor voltage provided to the deck motor, and estimate a torque of the cutting blade based on the blade speed, the motor current, the motor voltage, and a torque profile of the deck motor. The controller is configured to reduce a speed limit of the propulsion system in response to the estimated torque being greater than an upper torque threshold.

In another aspect, the present disclosure relates to a method for operating a grounds maintenance machine comprising determining a rotational speed of a cutting blade of a cutting deck of the grounds maintenance machine, determining a current provided to a deck motor of the cutting deck, determining a voltage provided to the deck motor, and estimating a torque of the cutting blade based on the rotational speed, the current, the voltage, and a torque profile of the deck motor. The method comprises adjusting, based on the estimated torque of the cutting blade, one or both of a speed limit of a propulsion system of the grounds maintenance machine and a speed of the cutting blade.

The summary is not intended to describe each embodiment or every implementation of the present disclosure. A more complete understanding will become apparent and appreciated by reference to the following detailed description and claims taken in view of the accompanying figures of the drawing.

### BRIEF DESCRIPTION OF THE DRAWINGS

Illustrative embodiments will be further described with reference to the figures of the drawing, wherein:

FIG. 1 is a perspective view of a grounds maintenance machine, e.g., a ride-on mower according to embodiments described herein.

FIG. 2 is a system block diagram of a grounds maintenance machine, such as that shown in FIG. 1.

FIG. 3 is a graph depicting an example relationship between rotational speed and torque.

FIG. 4 is a flowchart illustration of an example of a method of torque monitoring for a grounds maintenance machine.

FIG. 5 is a flowchart illustration of a portion of the method of FIG. 4.

FIG. 6 is a flowchart illustration of another portion of the method of FIG. 4.

FIG. 7 is a flowchart illustration of a further portion of the method of FIG. 4.

The figures are rendered primarily for clarity and, as a result, are not necessarily drawn to scale. Moreover, various structure/components, including but not limited to fasteners, electrical components (wiring, cables, etc.), and the like, may be shown diagrammatically or removed from some or all of the views to better illustrate aspects of the depicted embodiments, or where inclusion of such structure/components is not necessary to an understanding of the various illustrative embodiments described herein. The lack of illustration/description of such structure/components in a particular figure is, however, not to be interpreted as limiting the scope of the various embodiments in any way.

### DETAILED DESCRIPTION

In the following detailed description of illustrative embodiments, reference is made to the accompanying figures of the drawing which form a part hereof. It is to be understood that other embodiments, which may not be described and/or illustrated herein, are certainly contemplated.

All headings provided herein are for the convenience of the reader and should not be used to limit the meaning of any text that follows the heading, unless so specified. Moreover, unless otherwise indicated, all numbers expressing quantities, and all terms expressing direction/orientation (e.g., vertical, horizontal, parallel, perpendicular, etc.) in the specification and claims are to be understood as being modified in all instances by the term “about.” The term “and/or” (if used) means one or all of the listed elements or a combination of any two or more of the listed elements. The term “i.e.” is used as an abbreviation for the Latin phrase id est and means “that is.” The term “e.g.,” is used as an abbreviation for the Latin phrase exempli gratia and means “for example.”

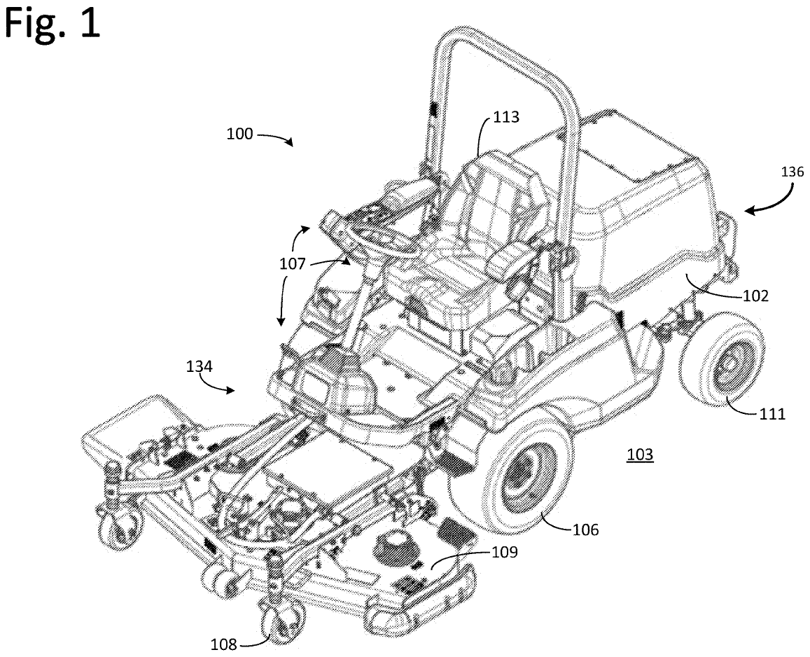

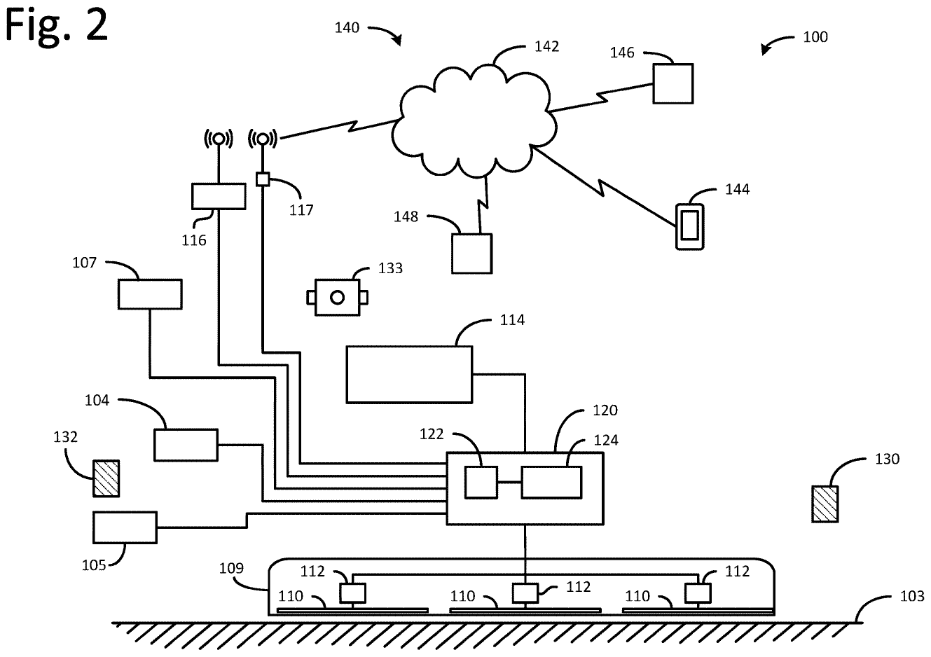

It is noted that the terms “have,” “include,” “comprises,” and variations thereof, do not have a limiting meaning, and are used in their open-ended sense to generally mean “including, but not limited to,” where the terms appear in the accompanying description and claims. Further, “a,” “an,” “the,” “at least one,” and “one or more” are used interchangeably herein. Moreover, relative terms such as “left,” “right,” “front,” “fore,” “forward,” “rear,” “aft,” “rearward,” “top,” “bottom,” “side,” “upper,” “lower,” “above,” “below,” “horizontal,” “vertical,” and the like may be used herein and, if so, are from the perspective shown in the particular figure, or while the machine 100 is in an operating configuration (e.g., while the machine 100 is positioned such that wheels 106 and 108 rest upon a generally horizontal ground surface 103 as shown in FIGS. 1 and 2). These terms are used only to simplify the description, however, and not to limit the interpretation of any embodiment described.

As used herein, the terms “determine,” “estimate,” and “generate” may be used interchangeably depending on the particular context of their use, for example, to determine or estimate a speed of the mower 100 or a feature, particularly with respect to data. Embodiments of the present disclosure provide grounds maintenance machine systems and methods to adjust machine speed limits and/or one or more implement (e.g., cutting blade) rotational speeds based on an estimated torque of the one or more implements. The grounds maintenance machine may be capable of manual operation using manual controls 107, autonomous operation, or both manual and autonomous operation.

While the construction of the actual grounds maintenance machine is not necessarily central to an understanding of embodiments of this disclosure, FIG. 1 illustrates one example of a grounds maintenance machine or mower 100. FIG. 2 is a system block diagram showing various components of the mower 100 shown in FIG. 1. It is noted that the components shown in FIG. 2 can be incorporated in a grounds maintenance machine that differs in construction and functionality from the representative mower 100 shown in FIG. 1.

FIG. 1 shows a perspective view of the mower 100 and FIG. 2 shows various components of the mower 100 illustrated in block diagram form. The mower 100 may include a frame 102 (e.g., a frame or chassis with a shroud) that carries and/or encloses various components of the mower 100 as described below. The mower 100 may further include ground support members, such as wheels, rollers, or tracks. In the illustrated embodiment, ground support members shown include drive wheels 106 and rear wheels 111 that together support the frame 102 upon a ground (grass) surface 103, and front wheels 108 that support an implement 109 (e.g., an implement deck) upon the ground surface 103. As illustrated, the drive wheels 106 are used to support a front end portion 134 of the frame 102 and the rear wheels 111 are used to support a rear end portion 136 of the frame 102.

The mower 100 shown in FIG. 1 is referred to as a ride-on mower, such that an operator can sit on a seat 113 and ride upon the mower 100 during mower operation. The mower 100 includes a propulsion system that causes the drive wheels 106 to rotate in a direction and rate dictated by command signals received from operator controls 107. In some embodiments, the propulsion system can cause both the drive wheels 106 and the rear wheels 111 to rotate in a direction and rate dictated by command signals received from the operator controls 107. The operator controls 107 can include a direction control, a steering wheel, a velocity control, and a brake mechanism. The direction control can be positioned by the operator to cause the mower 100 to move in a forward or reverse direction. The steering wheel can be rotated by the operator to steer the mower 100 in a desired direction via left/right movement of the drive wheels 106. The position of the velocity control can be adjusted by the operator to change the speed at which the drive wheels 106 (and possibly the rear wheels 111) are caused to rotate. The brake mechanism can be operated by the operator to slow or halt the forward or reverse progress of the mower 100.

In some embodiments, the propulsion system includes an internal combustion engine operatively coupled to the drive wheels 106 (and possibly the rear wheels 111). In other embodiments, and as shown in FIG. 2, the propulsion system includes an electric power source (e.g., battery 114) connected to electric wheel motors 104 coupled to the drive wheels 106 (and possibly to electric wheel motors 105 which drive the rear wheels 111). As shown in FIG. 1, the front wheels 108 may freely caster relative to the frame 102 (e.g., about vertical axes).

One or both rear wheels 106 may be driven by a propulsion system (e.g., including one or more electric wheel motors 104) to propel the mower 100 over the ground surface 103. In some embodiments, the front wheels 108 may freely caster relative to the frame 102 (e.g., about vertical axes). In such a configuration, mower direction may be controlled via differential rotation of the two rear wheels 106 in a manner similar to a conventional zero-turn-radius (ZTR) riding mower. That is to say, the propulsion system may include a separate wheel motor 104 for each of a left and right rear wheel 106 so that speed and direction of each rear wheel may be independently controlled. In addition, or alternatively, the front wheels 108 could be actively steerable by the propulsion system (e.g., including one or more steer motors 105) to assist with control of mower 100 direction, and/or could be driven by the propulsion system (i.e., to provide a front-wheel or all-wheel drive mower). While the mower 100 may be autonomously controlled or navigated, operator controls 107, may permit independent control of the speed and direction of each drive wheel 106, allowing operator control of mower speed and direction from a walking or riding position generally behind the mower 100.

Although the illustrated mower 100 has the drive wheels 106 in the mid-section, rear wheels 111 at the rear, and caster wheels 108 in front, this configuration is not limiting. For example, the mower 100 may be implemented as a stand-on or stand-behind mower having two rear drive wheels and two or more front caster wheels. Mower direction may be controlled via differential rotation of the two rear wheels in a manner similar to a conventional zero-turn-radius (ZTR) riding mower. That is to say, the propulsion system may include a separate wheel motor for each of a left and a right rear wheel so that speed and direction of each rear wheel may be independently controlled. In addition, or alternatively, the front wheels could be actively steerable by the propulsion system (e.g., via one or more steer motors) to assist with control of mower direction, and/or could be driven by the propulsion system (i.e., to provide a front-wheel or all-wheel drive mower). While the mower 100 may be autonomously controlled or navigated, operator controls may permit independent control of the speed and direction of each rear drive wheel, allowing operator control of mower speed and direction from a walking or riding position generally behind the mower 100. Other mower configurations may use different wheel configurations altogether, e.g., a tri-wheel configuration. These and other embodiments are certainly possible without departing from the scope of the present disclosure. Moreover, while illustrated herein as wheels, other ground engaging members (e.g., tracks, skids, etc.) are also contemplated.

An implement 109, e.g., implement deck, may be connected to the frame 102 or a lift arm (generally longitudinally in front of, mid-mounted between the drive wheels 106, or to the sides of the machine 100). The implement 109 (e.g., a cutting deck) may include one or more cutting blades 110. The cutting blades 110 may be operatively powered, via spindles of the motors 112. During operation, power may be selectively delivered to the motors 112, whereby the blades 110 rotate at a speed sufficient to sever grass and other vegetation as the implement 109 passes over the ground surface 103. As indicated above, other grounds maintenance machines 100 may locate the implement 109 above the frame 102, or at other locations along the lower side of the frame 102 (e.g., a forwardly-mounted or “out-front” deck configuration). Moreover, while illustrated as a cutting deck, the implement 109 may be any tool (e.g., aerator, spreader, sprayer etc.) that attaches to the frame 102.

The mower 100 may further include a power source, which in one embodiment is a battery 114 having a lithium-based chemistry (e.g., lithium-ion). Other embodiments may utilize batteries of other chemistries, or other power source technologies (e.g., solar power, fuel cell, internal combustion engines) altogether, without departing from the scope of this disclosure.

The mower 100 may further include one or more sensors to provide location data. For instance, some embodiments may include a global positioning system (GPS) receiver 116 (or other position sensor that may provide similar data) that is adapted to estimate a position of the mower 100 within a work region and provide such information to a controller 120 (described below). In other embodiments, one or more of the wheels 106, 108, 111 may include encoders that provide wheel rotation/speed information that may be used to estimate mower position (e.g., based upon an initial start position) within a given work region.

The mower 100 may include one or more front obstacle detection sensors 130 and one or more rear obstacle detection sensors 132, as well as other sensors, such as side obstacle detection sensors (not shown). The obstacle detection sensors 130, 132 may be used to detect an obstacle in the path of the mower 100 when travelling in a forward or reverse direction, respectively. The mower 100 may be capable of mowing while moving in either direction. The sensors 130, 132 may be located at the front end portion 134 or rear end portion 136 of the mower 100, respectively.

The sensors 130, 132 may use contact sensing, non-contact sensing, or both types of sensing. For example, both contact and non-contact sensing may be enabled concurrently or only one type of sensing may be used depending on the status of the mower 100 (e.g., within a zone or travelling between zones). One example of contact sensing includes using a contact bumper protruding from the frame 102 or a shroud of the frame 102 that can detect when the mower 100 has contacted the obstacle. Non-contact sensors may use acoustic or light waves to detect the obstacle, sometimes at a distance from the mower 100 before contact with the obstacle (e.g., using infrared, radio detection and ranging (radar), light detection and ranging (lidar), etc.).

The mower 100 may include one or more vision-based sensors to provide localization data, such as position, orientation, or velocity. The vision-based sensors may include one or more cameras 133 that capture or record images for use with a vision system. The cameras 133 may be described as part of the vision system of the mower 100. Types of images include, for example, training images and/or operational images.

The one or more cameras 133 may be capable of detecting visible light, non-visible light, or both. The one or more cameras 133 may establish a total field of view of at least 30 degrees, at least 45 degrees, at least 60 degrees, at least 90 degrees, at least 120 degrees, at least 180 degrees, at least 270 degrees, or even at least 360 degrees, around the autonomous machine (e.g., mower 100). The field of view may be defined in a horizontal direction, a vertical direction, or both directions. For example, a total horizontal field of view may be 360 degrees, and a total vertical field of view may be 45 degrees. The field of view may capture image data above and below the height of the one or more cameras 133.

In some embodiments, the mower 100 includes four cameras 133. One camera 133 may be positioned in each of one or more of directions including a forward direction, a reverse direction, a first side direction, and a second side direction (e.g., Cardinal directions relative to the mower 100). One or more camera directions may be positioned orthogonal to one or more other cameras 133 or positioned opposite to at least one other camera 133. The cameras 133 may also be offset from any of these directions (e.g., at a 45 degree or another non-right angle).

Sensors of the mower 100 may also be described as either vision-based sensors and non-vision-based sensors. Vision-based sensors may include cameras 133 that are capable of recording images. The images may be processed and used to build a three-dimensional point cloud (3DPC) or used for optical odometry (e.g., optical encoding). Non-vision-based sensors may include any sensors that are not cameras 133. For example, a wheel encoder that uses optical (e.g., photodiode), magnetic, or capacitive sensing to detect wheel revolutions may be described as a non-vision-based sensor that does not utilize a camera. Wheel encoding data from a wheel encoder may be also described as odometry data.

Optical encoding may be used by taking a series or sequence of images and comparing features in the images to determine or estimate a distance traveled between the images. Optical encoding may be less susceptible to wheel slippage than a wheel encoder for determining distance or speed.

In addition to the sensors described above, other sensors now known or later developed may also be incorporated into the mower 100.

The mower 100 may also include a controller 120 adapted to monitor and control various mower functions. The controller 120 may include a processor 122 that receives various inputs and executes one or more computer programs or applications stored in memory 124.

The memory 124 may include computer-readable instructions or applications that, when executed, e.g., by the processor 122, cause the controller 120 to perform various calculations and/or issue commands. That is to say, the processor 122 and memory 124 may together define a computing apparatus operable to process input data and generate the desired output to one or more components/devices. For example, the processor 122 may receive various input data including positional data from the GPS receiver 116 and/or encoders and generate speed and steering angle commands to the one or more wheel motors 104 to cause the drive wheels 106 to rotate. In other words, the controller 120 may control the steering angle and speed of the mower 100, as well as the speed and operation of the cutting blade.

In general, GPS data generated based on data from the GPS receiver 116 may be used in various ways to facilitate the determining of a pose of the mower 100. In some embodiments, GPS data may be used as one of the non-vision-based sensors to help determine non-vision-based pose data. The non-vision-based pose data may be updated or corrected using vision-based pose data. GPS data may also be used to facilitate updating or correcting an estimated pose, which may be based on non-vision-based pose data and/or vision-based pose data. In some embodiments, the GPS data may be augmented using a GPS-specific correction data, such as real-time kinematics (RTK) data. GPS-RTK data may provide a more accurate or precise location that corrects for anomalies in GPS timing compared to nominal GPS data.

Reference herein may be made to various parameters, data, or data structures, which may be handled in a controller 120, for example, by being processed by a processor 122 or stored in or retrieved from a memory 124.

The controller 120 may use the processor 122 and memory 124 in various different systems. In particular, one or more processors 122 and memory 124 may be included in each different system. In some embodiments, the controller 120 may at least partially define a vision system, which may include a processor 122 and memory 124. The controller 120 may also at least partially define a navigation system, which may include a processor 122 and memory 124 separate from the processor 122 and memory 124 of the vision system.

Each system may also be described as having its own controller 120. For example, the vision system may be described as including one controller 120 and the navigation system may be described as having another controller 120. As such, the mower 100 may be described as having multiple controllers 120. In general, as used herein, the term “controller” may be used to describe components of a “system” that provide commands to control various other components of the system.

In addition, a communication system 140 may be provided to permit the mower 100/controller 120 to operatively communicate (e.g., via a wireless radio 117) with a communication network such as a wireless network 142, thereby allowing communication (e.g., bidirectional communication) between the mower 100 and other devices. For example, the wireless network 142 may be a cellular or other wide area network, a local area network (e.g., Institute of Electrical and Electronics Engineers (IEEE) 802.11 local “Wi-Fi” network), or a personal area or peer-to-peer network (“P2P,” e.g., “Bluetooth” network). Other devices may communicate over the wireless network with the mower 100, including, for example, a remote computer 144, which may be configured as a mobile/cellular phone, tablet, desktop computer, notebook computer, or wearable computer. Preferably, the wireless network 142 is connected to the Internet so that the user/remote computer 144 may interact with the communication system 140 regardless of the user's location. Moreover, connection of the wireless network 142 to the Internet allows communication with most any other remote computer including, for example, an internet (cloud)-based server 146.

The communication system 140 may also permit communication over the wireless network with a base station 148. Although not specifically illustrated, the communication system 140 may include conventional network hardware including gateways, routers, wireless access points, etc. (not shown).

While illustrated as using a centralized communication network (e.g., wherein each device connects to a central network), other embodiments may utilize a decentralized or ad-hoc network, wherein communication occurs directly between devices. Still further, while illustrated as primarily utilizing wireless communication protocols, such a configuration is not limiting as, for example, various devices (e.g., the base station 148) could connect to the communication network or other devices using wired connections without departing from the scope of this disclosure.

In view of the above, it will be readily apparent that the functionality of the controller 120 may be implemented in any manner known to one skilled in the art. For instance, the memory 124 may include any volatile, non-volatile, magnetic, optical, and/or electrical media, such as a random-access memory (RAM), read-only memory (ROM), non-volatile RAM (NVRAM), electrically-erasable programmable ROM (EEPROM), flash memory, and/or any other digital media. While shown as both being incorporated into the controller 120, the memory 124 and the processor 122 could be contained in separate modules.

The processor 122 may include any one or more of a microprocessor, a controller, a digital signal processor (DSP), an application specific integrated circuit (ASIC), a field-programmable gate array (FPGA), and/or equivalent discrete or integrated logic circuitry. In some embodiments, the processor 122 may include multiple components, such as any combination of one or more microprocessors, one or more controllers, one or more DSPs, one or more ASICs, and/or one or more FPGAs, as well as other discrete or integrated logic circuitry. The functions attributed to the controller 120 and/or processor 122 herein may be embodied as software, firmware, hardware, or any combination of these. Certain functionality of the controller 120 may also be performed in the cloud or other distributed computing systems operably connected to the processor 122.

In FIG. 2, schematic connections are generally shown between the controller 120 and the battery 114, one or more wheel motors 104, 105, blade motors 112, wireless radio 117, and GPS receiver 116. This interconnection is illustrative only as the various subsystems of the mower 100 could be connected in most any manner, e.g., directly to one another, wirelessly, via a bus architecture (e.g., controller area network (CAN) bus), or any other connection configuration that permits data and/or power to pass between the various components of the mower. Although connections with some of the sensors 130, 132, 133 are not shown, these sensors and other components of the mower 100 may be connected in a similar manner. The wireless radio 117 may communicate over a cellular or other wide area network (e.g., even over the Internet), a local area network (e.g., IEEE 802.11 “Wi-Fi” radio), or a peer-to-peer (P2P) (e.g., BLUETOOTH™) network with a mobile device 144 (e.g., mobile computing device, mobile computer, handheld computing device, smartphone, cellular phone, tablet, desktop, or wearable computer, smartwatch, etc.). In turn, the remote computer 144 may communicate with other devices over similar networks and, for example, may be used to connect the mower 100 to the Internet.

The controller 120 may be operatively coupled to the propulsion system and the deck motor. The controller 120 may be configured to control a speed of the mower 100 using the propulsion system. The controller 120 may be configured to set or provide a speed limit of the propulsion system. The speed limit may be dynamically adjusted to maintain various operating parameters of the mower 100. For example, the speed limit may be set or adjusted below an input speed. The input speed may be a manual input provided by a user in real time or a predetermined operational speed. The predetermined operational speed may be a speed requested by a user or a typical operational speed for autonomous functionality. The speed limit may be reduced, for example, when sensor values or signals indicate that the mower has encountered increased amounts of vegetation to be cut or that the input speed is negatively impacting efficiency or performance.

The controller 120 may also be configured to monitor and control parameters of the cutting blades 110 and deck motors 112. The controller 120 may be configured to determine a rotational speed of the cutting blades 110. The rotational speed of any particular cutting blade 110 of the mower deck 109 may be determined based on a speed of a corresponding deck motor 112. Each of the cutting blades 110 may be operatively coupled to a spindle, alternatively referred to as a motor spindle or blade spindle, of one of the deck motors 112 to allow each of the deck motors 112 to rotate one of the cutting blades 110. Accordingly, a rotational speed of a motor 112 may be proportional to a blade speed of the motor's corresponding cutting blade 110.

In general, the motor 112 and the cutting blade 110 may be coupled in a manner that the motor 112 and the cutting blade 110 complete a revolution at the same rate. Alternatively, the motor 112 and the cutting blade 110 may be coupled in a manner that revolutions are completed at different rates, albeit in a proportional manner. For example, a gearing system may be utilized to increase or decrease the number of revolutions completed by the cutting blade 110 for each revolution of the motor 112. Additionally, a blade tip speed of the cutting blade 110 is dependent on both a length of the cutting blade 110 and a rotational speed of the cutting blade 110 or motor 112. For example, a first blade tip having a distance of 12 inches from the axis of rotation or spindle will have double the blade tip speed of a second blade tip having a distance of 6 inches from the axis of rotation at the same rotational speed of the cutting blade 110 or motor 112.

The controller 120 may be configured to determine a speed of the cutting blade 110. The speed of the cutting blade 110 may be determined from a speed of the deck motor 112 or a sensor configured to sense a blade tip speed of the cutting blade 110. For example, the controller 120 may include or be operatively coupled to a motor controller for the deck motor 112 that controls and monitors the speed of the motor 112.

Additionally, the controller 120 may be configured to determine a motor current and a motor voltage provided to the deck motor 112. Power may be provided by the controller 120 or power provided to the deck motor 112 may be regulated by the controller 120 or a motor controller operatively coupled to the controller. Accordingly, the controller 120 may measure the current and voltage of the power provided to the deck motor 112 (e.g., the motor current and motor voltage) or receive signals indicative of the motor current and motor voltage from a motor controller or sensor.

In general, current provided to an electric mower may be indicative of torque supplied by an electric motor (e.g., deck motors 112) at operation below the knee point voltage. However, the use of motor controllers (e.g., the controller 120) may allow efficient operation of electric motors at voltages above the knee point voltage. Above the knee point voltage, the motor current may have a non-linear relationship to motor or cutting blade torque. Furthermore, the controller 120 may be configured to operate the deck motors 112 above a knee point voltage of the deck motors. In other words, a voltage of the power provided to the deck motors 112 may be greater than a knee point voltage of the deck motors 112. Thus, motor current alone may be insufficient to determine or estimate torque above a knee point voltage of the deck motors 112.

The controller 120 may be configured to estimate a torque of the cutting blade 110 based on the speed of the cutting blade, the motor current, the motor voltage, and a torque profile of the deck motor. The torque profile may be, for example, a map, one or more equations, a look up table, or another function that allows a torque of the cutting blade 110 to be estimated using the speed of the cutting blade, the motor current, and the motor voltage.

A torque profile for each deck motor 112 may be determined prior to assembly of the mower 100 or during a calibration or setup process of the mower 100. To generate a torque profile for each deck motor 112, motor parameters, including a rotational speed, a motor current, a motor voltage, and a torque of each deck motor 112 may be measured (e.g., sampled) over an operational range of each deck motor 112. Additionally, the motor parameters may be measured under load conditions that range from no load to a maximum load. No load may simulate conditions where the cutting blade 110 experiences no resistance from the cutting of plant or other matter. In contrast, the maximum load may correspond to or simulate the maximum amount of resistance from plant or other matter that the cutting blade 110 can experience without damage to the deck motor 112.

The sampled motor parameters can be used by a look up table, one or more equations, a piecewise function, or other functions that allow torque to be estimated based on the speed of the cutting blade, the motor current, and the motor voltage. The rotational speed of the deck motor 112 can be represented as rotations per minute which can be used to determine the speed of the cutting blade 110 corresponding to the deck motor 112. While a single motor current value may correspond to multiple torque values, unique combinations of blade speed and motor current and voltage values may correspond to a single torque value. In other words, a single measured blade speed value, a single measured motor current value, and a single measured motor voltage value will correspond to a single torque value or estimate. While samples of the motor parameters provide torque values for discrete values of blade speed and motor current and voltage, statistical methods or interpolation can be utilized to generate torque profiles that can estimate torque for any blade speeds and motor currents and voltages within operational conditions of the mower 100. For example, a linear fit, a piecewise approximation, or other interpolation method may be used to generate the torque profiles for each motor from the samples of motor parameters.

The use of blade speed and motor current may allow the torque of each of the cutting blades to be determined or estimated when the deck motors 112 are operated above a knee point voltage of the deck motors. While torque and motor current may have a linear relationship when an electric motor is operated below the knee point voltage of such motor, torque may not be derivable based on the motor current alone when the electric motor is operated above the knee point voltage. Furthermore, the use of motor controllers (e.g., the controller 120) may allow electric motors (e.g., the deck motors 112) to operate efficiently above the knee point voltage. In contrast, electric motors operated without a motor controller may generally be operated below the knee point voltage to maintain efficiency.

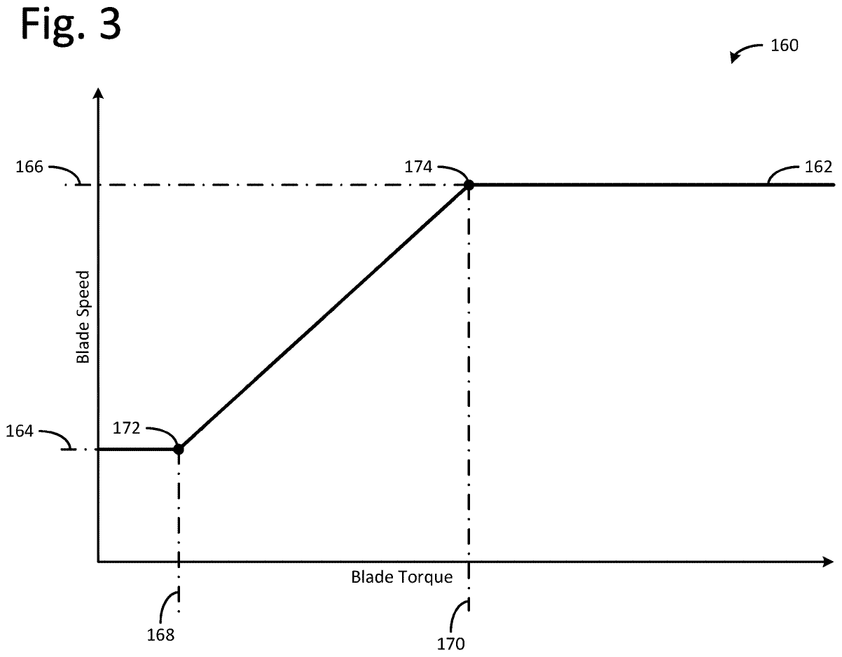

A generalized relationship between torque and rotational speed of a deck motor (e.g., deck motors 112) is depicted in a graph 160 of FIG. 3. Blade torque is depicted along the X-axis and rotational speed (e.g., blade speed) is depicted along the Y-axis. Accordingly, the line 162 depicts an example relationship between torque and rotational speed of the deck motor 112. The controller 120 may be configured to maintain a rotational speed and torque of each of the deck motors 112 within appropriate operational ranges. The typical operational range of the rotational speed may be defined from a minimum speed 164 to a maximum speed 166. Furthermore, the typical operational range of the torque may be defined from a minimum torque 168 to a maximum torque 170.

The operational range of the rotational speed of the motor may depend on the particular parameters of the cutting blade 110 and the deck motor 112. In general, the operational range of the rotational speed of the motor may correspond to any suitable or desirable range for a blade tip speed of the cutting blade 110. In one or more embodiments, the minimum speed 164 may correspond to a blade tip speed of at least 14,500 feet per minute and the maximum speed 166 may correspond to a blade tip speed of no greater than 17,500 feet per minute. Additionally, the operational range of the torque supplied by the motor may also depend on the particular parameters of the cutting blade 110 and the deck motor 112. In one or more embodiments, the minimum torque 168 may be at least 1 Newton meter and the maximum torque 170 may be no greater than 10 Newton meters.

The graph 160 depicts the typical operational range of the grounds maintenance machine 100 along the line 162 between points 172 and 174. Between the points 172 and 174 the motor speed and torque may have a proportional relationship. The controller 120 may be configured to maintain a blade tip speed of the cutting blade between the minimum speed 164 and the maximum speed 166 regardless of the motor torque. Accordingly, the motor torque may vary at the minimum speed 164 and the maximum speed 166.

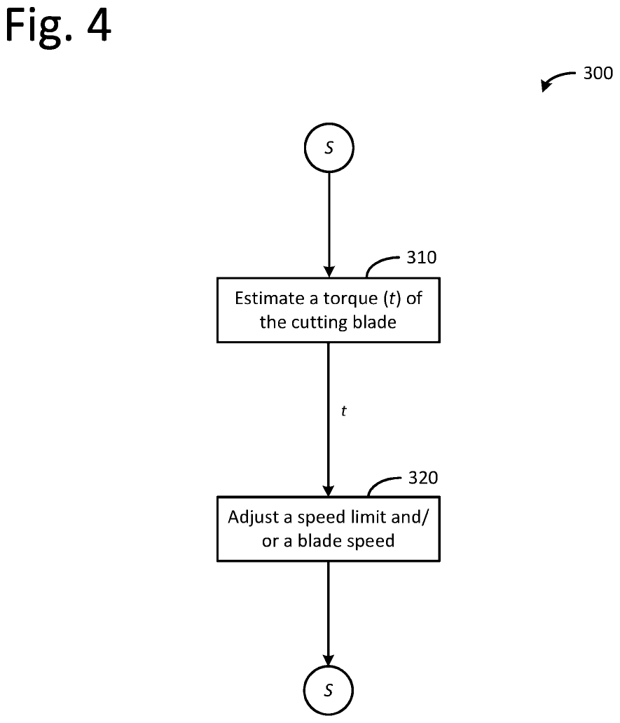

A method 300 for operating a grounds maintenance machine (e.g., mower 100) is depicted in FIGS. 4-7. The method 300 may be carried out or otherwise executed by a controller (e.g., controller 120) of the grounds maintenance machine. In other words, the controller 120 may be configured to carry out the method 300. Additionally, the controller 120 may utilize various systems (e.g., the propulsion system) and sensors to carry out the method 300. Although described with regard to mower 100 of FIGS. 1 and 2, the method 300 may be carried out by any suitable grounds maintenance machine or mower.

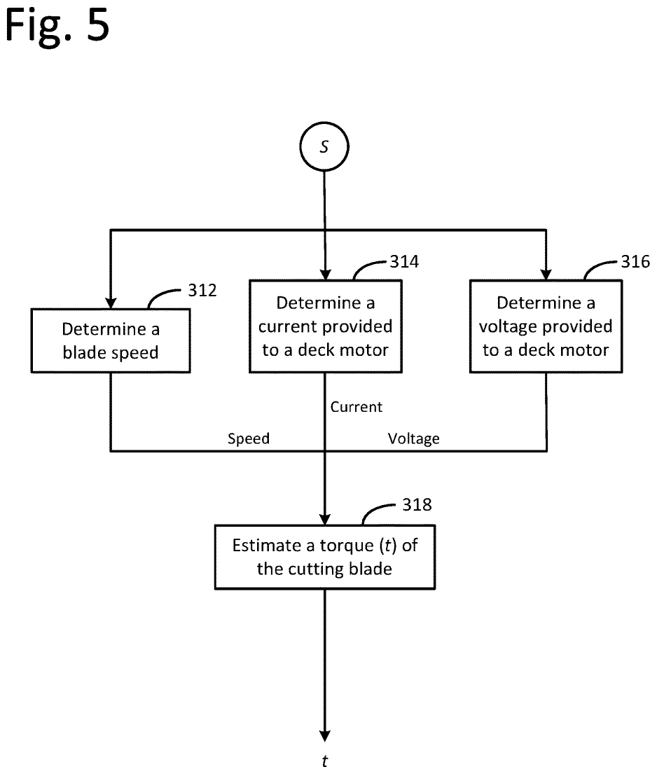

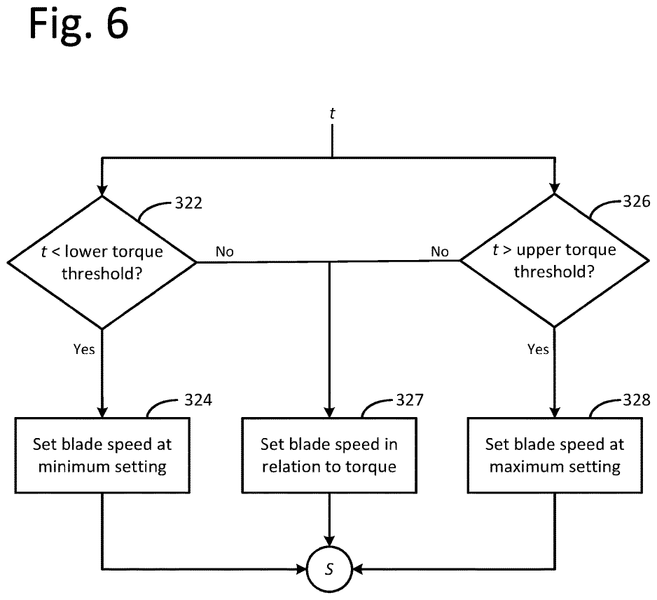

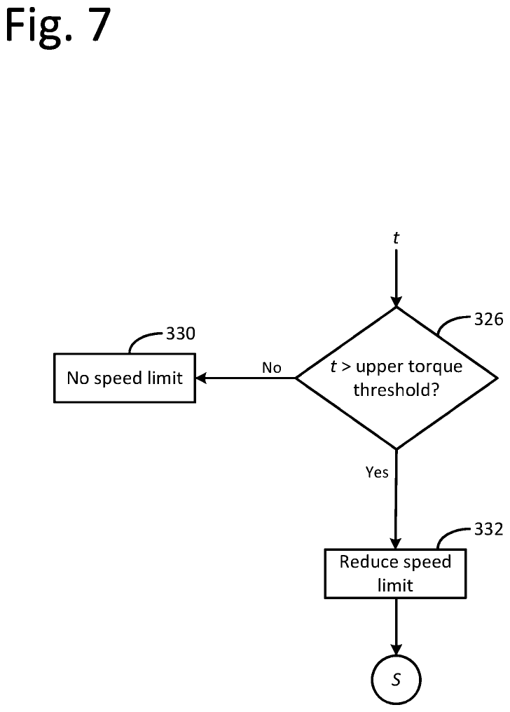

In general, the method 300 may include estimating a torque (t) of a cutting blade 110 at 310 and adjusting, based on the estimated torque, a speed limit of a propulsion system of the grounds maintenance machine 100 or a blade speed of the cutting blade 110 at 320 as depicted in FIG. 4. The step or process at 310 of estimating torque is depicted in greater detail in FIG. 5 and the step or process at 320 is depicted in greater detail in FIGS. 6 and 7.

As shown in FIG. 5, the method 300 may include determining a blade speed of a cutting blade 110 of the grounds maintenance machine at 312. The blade speed may be determined based on a rotational speed of a deck motor 112 operatively coupled to the cutting blade 110. The rotational speed of the deck motor 112 may be provided or set by a motor controller (e.g., the controller 120). Additionally, a blade tip speed of the cutting blade 110 or a rotational speed of the cutting blade 110 may be proportional to the rotational speed of the deck motor 112 and derivable therefrom. In one or more embodiments, the blade speed may be sensed by a sensor of the mower 100. The sensor may be configured to sense a blade tip speed of the cutting blade 110 or a rotational speed of the cutting blade 110.

The method 300 may include determining a motor current provided to the deck motor 112 of the cutting deck 109 at 314. The motor current may be monitored or controlled by the controller 120. Alternatively, the current provided to the deck motor 112 may be sensed by a current sensor and provided to the controller 120. The current sensor may include, for example, a hall effect current sensor, a current sense resistor, or other sensor or device capable of sensing a current.

The method 300 may further include determining a motor voltage provided to the deck motor 112 of the cutting deck 109 at 316. The motor voltage may be monitored or controlled by the controller 120. Alternatively, the voltage provided to the deck motor 112 may be sensed by a voltage sensor and provided to the controller 120. The voltage sensor may be implemented, for example, as a capacitive voltage sensor, a resistive voltage sensor, or other sensor or device capable of sensing a voltage.

The steps or processes 312, 314, 316 of the method 300 may be carried out in any desirable order or even concurrently. While the blade speed of the cutting blade 110 and the current provided to the deck motor 112 may be interrelated, the determinations of the rotational speed of the cutting blade 110 and the current and voltage provided to the deck motor 112 can be carried out independently of one another.

The method 300 may further include estimating the torque of the cutting blade 110 based on the blade speed, the motor current, the motor voltage, and a torque profile of the deck motor 112 at 318. The torque profile may be, for example, a map, one or more equations, a look up table, or another function that allows a torque of the cutting blade 110 to be estimated using the speed of the cutting blade, the motor current, and the motor voltage. A torque profile for each deck motor 112 may be determined prior to assembly of the mower 100 or during a calibration or setup process of the mower 100. To generate a torque profile for each deck motor 112, motor parameters, including a rotational speed, a motor current, a motor voltage, and a torque of each deck motor 112, may be measured (e.g., sampled) over an operational range of each deck motor 112. Additionally, the motor parameters may be measured under load conditions that range from no load to a maximum load. No load may simulate conditions where the cutting blade 110 experiences no resistance from the cutting of plant or other matter. In contrast, the maximum load may correspond to or simulate the maximum amount of resistance from plant or other matter that the cutting blade 110 can experience without damage to the deck motor 112. In one or more embodiments, the torque profile maps blade speeds of the cutting blade and motor current of the deck motor to torques of the cutting blade based on a dyno map of the deck motor 112.

The method 300 may further include adjusting, based on the estimated torque of the cutting blade, a speed limit of a propulsion system of the grounds maintenance machine and/or a speed of the cutting blade 110 at 320. Adjusting the speed limit of the propulsion system may be implemented in response to the estimated torque exceeding an upper torque threshold (see, e.g., FIG. 7). Adjusting the speed of the cutting blade may be implemented in response to the estimated torque being less than a lower torque threshold, greater than an upper torque threshold, or within an operational torque range, which may be a range from at least the lower torque threshold to no greater than the upper torque threshold (see, e.g., FIG. 6).

As shown in FIG. 6, the method 300 may include comparing the estimated torque to one or more torque thresholds. The method 300 may include comparing the torque to a lower torque threshold at 322. The lower torque threshold may be a predetermined value based on one or more of the calibrated motor parameters, expected load conditions, or the torque profile of the particular deck motor 112. The method 300 may also include determining whether the estimated torque is greater than an upper torque threshold at 326. The upper torque threshold may be a predetermined value based on one or more of the calibrated motor parameters, expected load conditions, the torque profile of the particular deck motor 112, or a maximum torque limit of the cutting blade 110 or deck motor 112. The steps or processes 322 and 326 of the method 300 may be carried out in any desirable order or even concurrently.

If the estimated torque is less than the lower torque threshold, the blade speed may be reduced at 324. In other words, the method 300 may further include reducing the speed of the cutting blade 110 in response to the estimated torque being less than the lower torque threshold. The speed of the cutting blade 110 may be reduced to any suitable speed. In one or more embodiments, the speed of the cutting blade 110 may be reduced to the minimum speed 164.

Although torque and blade speed are generally related, the load (e.g., amount of grass or vegetation being cut) of the cutting blade 110 may also impact torque. In other words, the amount of grass or vegetation being cut provides resistance to rotation of the cutting blade 110 and alters the twisting or turning force (e.g., torque) required to maintain a particular blade speed. For example, areas with denser and/or longer vegetation may require more power (e.g., greater motor current) and torque to maintain a particular blade speed than areas with little to no vegetation at a cutting height of the cutting blade 110. A drop in torque of the cutting blade 110 may indicate that the cutting blade 110 is cutting little or no vegetation and, therefore, does not need as much power to cut the vegetation in the present location. Thus, while under little or no load, power may be wasted by providing more power or current to the deck motor than needed. By monitoring the torque of the cutting blade 110, power provided to the cutting blade 110 can be dynamically adjusted to reduce wasted power when under light or no-load conditions.

If the estimated torque is greater than the lower torque threshold, the estimated torque may be compared to the upper torque threshold at 326. If the estimated torque is greater than the upper torque threshold, the blade speed may be set to the maximum speed 166.

If the estimated torque is determined to be greater than the lower torque threshold and less than the upper torque threshold, then the blade speed of one or more of the cutting blades 110 may be adjusted at 327 in relation to the estimated torque between the upper and lower torque thresholds. In other words, the method 300 may further include setting the speed of the cutting blade 110 to a speed related to the estimated torque in response to the estimated torque being greater than the lower torque threshold and less than the upper torque threshold.

As is shown in FIG. 7, if the estimated torque does not exceed the upper torque threshold at 326, no speed limit is imposed on the propulsion system of the grounds maintenance machine 100. If the estimated torque is greater than the upper torque threshold, the speed limit of the propulsion system may be reduced at 332. In other words, the method 300 may further include reducing a speed limit of the propulsion system in response to the estimated torque being greater than an upper torque threshold at 332. The speed limit of the propulsion system may be reduced to any suitable speed limit. Additionally, reduction of the speed limit may be a single adjustment from a current speed limit to a reduced speed limit or the reduction of the speed limit may be an iterative process that includes multiple adjustments to the speed limit.

In one or more embodiments, reduction of the speed limit may include reducing the speed limit based on a difference between the upper torque threshold and the estimated torque. For example, the speed limit may be reduced in relation to the difference between the upper torque threshold and the estimated torque. In other words, higher estimated torque values may correspond to greater reductions in the speed limit.

In one or more embodiments, reduction of the speed limit may include reducing the speed limit by a predetermined amount. The predetermined amount may be in a range of at least 0.1 mph to no greater than 1 mph. As can be seen from the flow chart of method 300 depicted in FIGS. 4-6, reduction of the speed limit by a predetermined amount may result in an iterative reduction in the speed limit. For example, if reduction of the speed limit by the predetermined amount does not result in the torque falling below the upper torque threshold, when the method 300 returns to the start(S), the torque estimated at 310 may be greater than the upper torque threshold and the speed limit may again be reduced by the predetermined amount at 320. Accordingly, the speed limit may be iteratively reduced until the torque of the cutting blade 110 is below the upper torque threshold.

In one or more embodiments, reduction of the speed limit may include reducing the speed limit to a minimum operational speed. The minimum operational speed may be in the range of 0-3 mph.

The steps or processes 322 and 326 of the method 300 may be carried out in any desirable order or even concurrently. Furthermore, if the estimated torque is determined to be less than the lower torque threshold, the method 300 may set the blade speed to the minimum speed 324 without comparing the estimated torque to the upper torque threshold. Similarly, if the estimated torque is determined to be greater than the upper torque threshold, the method 300 may set the blade speed to a maximum speed at 328 without comparing the estimated torque to the lower torque threshold.

Although the steps or processes of the method 300 are described in regard to a single cutting blade 110, the steps or processes of the method 300 may be applied to each cutting blade 110 and deck motor pair in any desirable order or even concurrently. In other words, the method 300 may include estimating the torque of each of the cutting blades 110 at 310 and adjusting, based on the estimated torques, a speed limit of the propulsion system of the grounds maintenance machine 100 and/or a blade speed of one or more of the cutting blades 110 at 320. Accordingly, the method 300 may be utilized to independently adjust a speed of each of the plurality of cutting blades 110 based on individually estimated torques of each of the cutting blades 110. Furthermore, the speed limit of the propulsion system may be adjusted based on the estimated torques of each of the cutting blades 110 in an individual or collective manner.

While the present disclosure is not so limited, an appreciation of various aspects of the disclosure will be gained through a discussion of the specific illustrative aspects provided below. Various modifications of the illustrative aspects, as well as additional aspects of the disclosure, will become apparent herein.

Thus, various embodiments of a grounds maintenance machine having a cutting deck with torque monitoring are disclosed. Although reference is made herein to the accompanying set of drawings that form part of this disclosure, one of at least ordinary skill in the art will appreciate that various adaptations and modifications of the embodiments described herein are within, or do not depart from, the scope of this disclosure. For example, aspects of the embodiments described herein may be combined in a variety of ways with each other.

Therefore, it is to be understood that, within the scope of the appended claims, the claimed embodiments may be practiced other than as explicitly described herein.

All references and publications cited herein are expressly incorporated herein by reference in their entirety into this disclosure, except to the extent they may directly contradict this disclosure.

All scientific and technical terms used herein have meanings commonly used in the art unless otherwise specified. The definitions provided herein are to facilitate understanding of certain terms used frequently herein and are not meant to limit the scope of the present disclosure.

The recitation of numerical ranges by endpoints includes all numbers subsumed within that range (e.g., 1 to 5 includes 1, 1.5, 2, 2.75, 3, 3.80, 4, and 5) and any range within that range. Herein, the terms “up to” or “no greater than” a number (e.g., up to 50) includes the number (e.g., 50), and the term “no less than” a number (e.g., no less than 5) includes the number (e.g., 5).

The terms “coupled” or “connected” refer to elements being attached to each other either directly (in direct contact with each other) or indirectly (having one or more elements between and attaching the two elements). Either term may be modified by “operatively” and “operably,” which may be used interchangeably, to describe that the coupling or connection is configured to allow the components to interact to carry out at least some functionality (for example, a propulsion controller may be operably coupled to a motor driver to electrically control operation of the motor).

Reference to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout are not necessarily referring to the same embodiment of the disclosure. Furthermore, the particular features, configurations, compositions, or characteristics may be combined in any suitable manner in one or more embodiments.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

1. A grounds maintenance machine, comprising:
a frame comprising a front end and a rear end;
one or more drive members connected to the frame and adapted to propel the machine over a ground surface;
a propulsion system configured to provide power to each of the one or more drive members;
a cutting deck connected to the frame and comprising:
a cutting blade; and
a deck motor operatively coupled to the cutting blade to rotate the cutting blade; and
a controller comprising one or more processors and operatively coupled to the propulsion system and the deck motor, the controller configured to:
determine a blade speed of the cutting blade;
determine a motor current provided to the deck motor;
determine a motor voltage provided to the deck motor;
estimate a torque of the cutting blade based on the blade speed, the motor current, the motor voltage, and a torque profile of the deck motor; and
adjust, based on the estimated torque of the cutting blade, one or both of:
a speed limit of the propulsion system; and
the blade speed of the cutting blade.

2. The grounds maintenance machine as in claim 1, wherein the torque profile maps blade speeds of the cutting blade, and motor current and motor voltage of the deck motor to torques of the cutting blade based on a dyno map of the deck motor.

3. The grounds maintenance machine as in claim 1, wherein the controller is configured to reduce the speed limit of the propulsion system in response to the estimated torque exceeding an upper torque threshold.

4. The grounds maintenance machine as in claim 1, wherein the controller is configured to reduce the speed of the cutting blade in response to the estimated torque being less than a lower torque threshold.

5. The grounds maintenance machine as in claim 4, wherein the controller is configured to set the speed of the cutting blade at a minimum setting.

6. The grounds maintenance machine as in claim 1, wherein the controller is configured to increase the speed of the cutting blade in response to the estimated torque being greater than an upper torque threshold.

7. The grounds maintenance machine as in claim 6, wherein the controller is configured to set the speed of the cutting blade at a maximum setting.

8. The grounds maintenance machine as in claim 1, wherein the controller is configured to set the speed of the cutting blade to a blade speed related to the estimated torque in response to the estimated torque being greater than a lower torque threshold and less than an upper torque threshold.

9. The grounds maintenance machine as in claim 1, wherein the cutting deck comprises a plurality of deck motors and a plurality of cutting blades.

10. A grounds maintenance machine, comprising:
a frame comprising a front end and a rear end;
one or more drive members connected to the frame and adapted to propel the machine over a ground surface;
a propulsion system configured to provide power to each of the one or more drive members;
a cutting deck connected to the frame and comprising:
a cutting blade;
a blade spindle operatively coupled to the cutting blade;
a deck motor operatively coupled to the blade spindle to rotate the cutting blade; and
a controller comprising one or more processors and operatively coupled to the propulsion system and the cutting deck, the controller configured to:
determine a rotational speed of the cutting blade;
determine a current provided to the deck motor;
determine a voltage provided to the deck motor;
estimate a torque of the cutting blade based on the rotational speed, the current, the voltage, and a torque profile of the deck motor;
set the rotational speed of the cutting blade to a minimum speed in response to the estimated torque being less than a lower torque threshold;
set the rotational speed of the cutting blade to a maximum speed in response to the estimated torque being greater than an upper torque threshold; and
adjust the speed of the cutting blade to a blade speed related to the estimated torque in response to the estimated torque being greater than the lower torque threshold and less than the upper torque threshold.

11. The grounds maintenance machine as in claim 10, wherein the torque profile maps blade speeds of the cutting blade, and motor current and motor voltage of the deck motor to torques of the cutting blade based on a dyno map of the deck motor.

12. The grounds maintenance machine as in claim 10, wherein the controller is configured to reduce a speed limit of the propulsion system in response to the estimated torque exceeding the upper torque threshold.

13. The grounds maintenance machine as in claim 10, wherein the cutting deck comprises a plurality of deck motors and a plurality of cutting blades.

14.-18. (canceled)

19. A method for operating a grounds maintenance machine, the method comprising:
determining a rotational speed of a cutting blade of a cutting deck of the grounds maintenance machine;
determining a current provided to a deck motor of the cutting deck;
determining a voltage provided to the deck motor;
estimating a torque of the cutting blade based on the rotational speed, the current, the voltage, and a torque profile of the deck motor; and
adjusting, based on the estimated torque of the cutting blade, one or both of:
a speed limit of a propulsion system of the grounds maintenance machine; and
a speed of the cutting blade.

20. The method as in claim 19, wherein the torque profile maps speeds of the cutting blade, current levels of the deck motor, and voltage levels of the deck motor to a torque of the cutting blade based on a dyno map of the deck motor.

21. The method as in claim 19, comprising reducing the speed limit of the propulsion system in response to the estimated torque exceeding an upper torque threshold.

22. The method as in claim 19, comprising reducing the speed of the cutting blade in response to the estimated torque being less than a lower torque threshold.

23. The method as in claim 19, comprising increasing the speed of the cutting blade in response to the estimated torque being greater than an upper torque threshold.

24. The method as in claim 19, comprising setting the speed of the cutting blade to a blade speed related to the estimated torque in response to the estimated torque being greater than a lower torque threshold and less than an upper torque threshold.

25. The method as in claim 19, wherein:
the cutting deck comprises a plurality of deck motors and a plurality of cutting blades; and
the method is implemented for each of the deck motors and cutting blades.
